(19) United States
(12) Patent Application Publication
(10) Pub. No.: US 2026/0301157 A1
(43) Pub. Date: Oct. 1, 2026

(54) METHOD FOR DETECTING AN ANOMALY IN AN INDUSTRIAL MACHINE AND RELATED INDUSTRIAL MACHINE

(71) Applicant: G.D S.P.A, Bologna (IT)

(72) Inventors: Stefano SINIGARDI, Bologna (IT); Maurizio PUZZANGHERA, Bologna (IT); Andrea BIONDI, Bologna (IT); Luca CERATI, Bologna (IT)

(21) Appl. No.: 19/480,555

(22) PCT Filed: Apr. 22, 2024
(86) PCT No.: PCT/IT2024/050077

§ 371 Date: Oct. 31, 2025

(30) Foreign Application Priority Data
May 3, 2023 (IT) 102023000008751

(51) Int. Cl. G06T 7/00; B65G 43/02; G01N 21/84; G01N 21/88

(52) U.S. Cl. CPC G06T 7/001; B65G 43/02; G01N 21/8851; B65G 2203/0283; B65G 2203/041; G01N 2021/8411; G06T 2207/30164

(57) ABSTRACT

Method for detecting an anomaly in an industrial machine (1) comprising a member (2) which moves according to a succession of cycles of movement having a phase, the method comprising:—at a determined value of the phase of each cycle of movement, acquiring a respective image (30) of a portion (11) of industrial machine, to obtain a collection of images (31; 32; 33);—comparing an image of the collection of images (31; 32; 33) acquired in a given cycle of movement with one or more images of the collection of images acquired respectively in one or more cycles of movement prior to the given cycle of movement;-as a function of the comparing, determining the presence of an anomaly in the industrial machine.

### TECHNICAL FIELD OF THE INVENTION

The present invention relates to a method for detecting an anomaly in an industrial machine, and a related industrial machine.

### STATE OF THE ART

In the field of industrial machines, particularly those used for processing products (e.g., filling, sealing, packaging, wrapping, cleaning, sterilization, etc.), anomalies in the machine or in its operation can occur, such as breakages of components, slip between components, jams, for example due to leakage of product, or of parts thereof, from the predefined path, etc.

Such anomalies can lead to risks of reduced production efficiency and/or product quality, machine downtime, and/or the need for costly repairs.

### SUMMARY OF THE INVENTION

For the purposes of the present invention, the term “phase” of a cycle of movement of a member refers to a parameter whose value uniquely defines a specific point in the cycle of movement.

Typically, as the cycle of movement progresses, the value of the phase changes (typically continuously, possibly even non-linearly with time) within a finite interval whose endpoints correspond to the beginning and to the end of the cycle (the value of the phase typically returning to the value of the opposite endpoint at the beginning of the next cycle).

For example, the phase can be expressed in trigonometric degrees and vary continuously within the interval from 0° to 360°, endpoints included.

Depending on the cycle of movement, the member may be in a different spatial position at each value of the phase (e.g., member moving along a closed path not comprising overlapping tracts, for example a circular path), or in a same spatial position at two (or more) values of the phase (e.g., member moving back and forth along a tract of the path or the entire path, for example a lever oscillating or a slider moving linearly back and forth).

The member can also move only in part of the cycle of movement and remaining stationary in the remaining part. In one embodiment, the phase of the cycle of movement of the member (or the respective phases of the cycles of movement of a plurality of moving mechanical members) is (are) synchronized with, or coincides with, a respective phase of a master motor (real or virtual) of the machine (called in the jargon “machine phase”), wherein this respective phase of the master motor is preferably detected by an encoder coupled to the physical master motor or by a controller of the virtual master motor.

By “two-dimensional image”, or “2D image”, of a portion of machine it is meant a digital image whose each pixel is associated with information representative of the reflectivity/diffusivity and/or of the colour of the portion of machine represented by said image, such as the images detected by common cameras or digital cameras (e.g., CCD) that work in the visible spectrum. In other words, the 2D image represents the visual appearance of the portion of machine.

By “matrix image” it is meant a digital image whose pixels form a rectangular matrix having the two dimensions of comparable length (for example the two dimensions differ by less than an order of magnitude, as in the 4×3 or 3×2 formats).

The Applicant believes that the known methods and systems for detecting anomalies in an industrial machine present some drawbacks and/or can be improved under some aspects.

For example, the Applicant believes that the known methods for detecting are not sufficiently precise and/or reliable in determining the onset of an anomaly, or they are very complex and/or expensive in terms of equipment and/or operation.

The Applicant has therefore faced the problem of detecting an anomaly in an industrial machine in simple (with low costs and/or low invasiveness on the machine) and/or reliable and/or rapid and/or precise way.

According to the Applicant, the aforementioned problem is solved by a method for detecting an anomaly and by a related industrial machine according to the attached claims and/or having one or more of the following features.

According to an aspect, the invention relates to a method for detecting an anomaly in an industrial machine.

Preferably the industrial machine comprises a member which moves according to a succession of cycles of movement having a phase.

Preferably said method comprises, at a determined value of said phase of each cycle of movement, acquiring a respective image of a portion of said industrial machine, to obtain a collection of images of said portion of industrial machine.

Preferably said method comprises comparing an image of said collection of images acquired in a given cycle of movement with one or more images of said collection of images acquired respectively in one or more cycles of movement prior to said given cycle of movement.

Preferably said method comprises, as a function of said comparing, determining the presence of an anomaly in said industrial machine.

According to an aspect, the invention relates to an industrial machine.

Preferably the industrial machine comprises a member movable according to a succession of cycles of movement having a phase.

Preferably the industrial machine comprises an image acquisition system, more preferably structured for acquiring an image of a portion of said industrial machine.

Preferably the industrial machine comprises a phase detector, more preferably structured for detecting in real time a value of said phase.

Preferably the industrial machine comprises a processing unit, more preferably connected to said image acquisition system and to said phase detector.

Preferably said processing unit is configured and programmed for receiving from said phase detector said value of said phase.

Preferably said processing unit is configured and programmed for, at a determined value of said phase of each cycle of movement, sending a control signal to said image acquisition system for acquiring a respective image of said portion of industrial machine.

Preferably said processing unit is configured and programmed for storing in memory said respective image acquired in each cycle of movement to obtain a collection of images of said portion of industrial machine.

Preferably said processing unit is configured and programmed for comparing an image of said collection of images acquired in a given cycle of movement with one or more images of said collection of images acquired respectively in one or more cycles of movement prior to said given cycle of movement.

Preferably said processing unit is configured and programmed for, as a function of said comparing, determining the presence of an anomaly in said industrial machine.

The Applicant has realized that the image of a portion of machine acquired at a certain value of the phase of a cycle of movement of a mechanical member (cyclically moving) of the industrial machine is representative of the physical state, or configuration, of this portion of machine (i.e. the set of mechanical members in their exact spatial position, and of any products, semi-finished products or parts thereof, which fall within the field of vision of the image acquisition device) at this specific value of the phase of the cycle of movement. Therefore, the physical state of the portion of machine results visually detectable from the acquired image, e.g., to the operator's eye and/or through image processing. In a comparative example, in which the control of the machine is entrusted solely to the control of the process parameters, some types of anomalies may not be detected, for example in the event of leakage of product, or parts thereof, from the predefined path, without consequences on the process parameters. With the image control, however, these types of anomalies are detectable.

The Applicant has also realized that, at each specific value of the phase and in the absence of anomalies (e.g., in the absence of damage and/or jamming of the machine), the physical state of the portion of machine remains ideally (substantially) the same for all the cycles of movement of the member. Therefore, by comparing (e.g., visually or through image processing algorithms) images all acquired exactly at a given value of the phase of subsequent cycles of movement (e.g., the aforementioned image acquired in a given cycle and the one or more images respectively acquired in one or more cycles of movement prior to said given cycle of movement), i.e. ideally perfectly coherent images, it is possible to verify the presence of a possible difference between the physical state assumed by the portion of machine in two (or more) different cycles of movement, this difference potentially being the symptom of an anomaly. The detection of the anomaly therefore results precise, reliable, simple (e.g., in operational terms) and/or immediate, even in the presence of an inexperienced operator.

The Applicant has also observed that, in general, during the operation of an industrial machine, variations in the speed of the phase of the cycle of movement may occur, for example following a setting by the operator (e.g., due to a changed production need or to a variation in the machine status, such as the degree of cleanliness or wear of a tool) and/or due to constraints imposed by other machines inserted (e.g., upstream and/or downstream) in the industrial line into which is inserted the machine in question and/or again during the transients during machine start-up or shutdown. The Applicant therefore considers it advantageous to acquire the images synchronously with the phase of the cycle of movement in order to take into account such speed variations from cycle to cycle and acquire and compare images that are perfectly coherent in terms of the ideal physical state of the machine. The Applicant believes that in an exemplary comparative case in which the acquisition of images occurs at regular time intervals (in other words synchronous with absolute time, or “constant frame rate”), it could happen that the images acquired in successive cycles are not representative of the portion of machine in the same ideal physical state, therefore making the comparison of little significance in order to detect the anomaly.

The present invention in one or more of the above aspects may exhibit one or more of the following preferred features.

Preferably the method comprises, at a plurality of determined values of said phase of each cycle of movement, said plurality of determined values comprising said determined value, acquiring a plurality of respective images of said portion of said industrial machine, to obtain a plurality of collections of images comprising said collection of images.

Preferably the method comprises, for each collection of images, comparing an image of said each collection of images acquired in said cycle of movement with one or more images of said each collection of images acquired respectively in said one or more cycles of movement prior to said given cycle of movement.

Preferably the method comprises, as a function of said comparing, determining the presence of an anomaly in said industrial machine.

In other words, the acquisition and comparison between images is performed for more than one value of phase in each cycle of movement, in order to increase the reliability and/or precision of the method.

Preferably the method comprises, at said determined value of said phase of each cycle of movement, acquiring a further respective image of a further portion of said industrial machine, to obtain a further collection of images.

Preferably the method comprises comparing a further image of said further collection of images acquired in said given cycle of movement with one or more further images of said further collection of images acquired respectively in said one or more cycles of movement prior to said given cycle of movement.

Preferably the method comprises, as a function of said comparing, determining the presence of an anomaly in said industrial machine.

In other words, the acquisition and comparison of images are performed simultaneously on multiple portions of the machine, in order to control the entire machine or at least the most critical parts.

Preferably said portion of machine at least partially comprises said member. Preferably said anomaly involves said member. In this way it is possible to detect anomalies connected to the member itself, e.g. bad positioning, breakages, wear, etc.

Preferably in said portion of machine passes/is placed a product (e.g. a raw material, a semi-finished product, a final product, etc.) under processing by said industrial machine. In this way it is possible to detect anomalies of the machine or of its functioning connected to the product being processed.

Preferably the method comprises acquiring in real time a value of said phase, more preferably by means of a phase detector. Preferably said phase detector comprises an encoder. In this way it is possible to easily detect the phase of the cycle of movement of the member.

Preferably said encoder is directly associated with said member to detect an angular position of said member. In this way, in case of member rotating on itself, it is advantageous to measure the phase directly on the member itself.

Preferably, acquiring in real time a value of said phase comprises directly acquiring in real time a value of a respective phase of a cycle of movement of a further member which moves according to a respective succession of cycles of movement having said respective phase in synchrony with said phase of the cycle of movement of said member. Preferably, acquiring in real time a value of said phase comprises calculating said value of said phase as a function of said respective acquired phase of the cycle of movement of said further member. Preferably said encoder is directly associated to said further member to detect a respective angular position of said further member. Preferably said respective angular position of said further member is correlated to said phase of the cycle of movement of said member. Preferably said phase detector is configured and programmed for calculating said value of said phase as a function of said angular position. Preferably it is provided calculating said value of said phase as a function of said angular position. Preferably said further member is a motor element structured for moving said member according to said succession of cycles of movement. Preferably the industrial machine comprises a motor element structured for moving said member according to said succession of cycles of movement.

In other words, it is possible to directly acquire the phase of a further member (e.g. a master motor or a member interconnected with the monitored member), while the phase of the member monitored in the images, which is synchronous with the phase of the further member, is acquired indirectly starting from the directly acquired phase.

Preferably said comparing said image with said one or more images comprises comparing a visual appearance of said portion of machine. Preferably said comparing is performed visually by an operator and/or via metric image processing algorithms and/or via image recognition algorithms. The visual comparison is complete and effective.

Preferably said comparing said image with said one or more images comprises comparing a spatial relationship between a position of a physical characteristic of said portion of machine in said image and a respective position of said physical characteristic in said one or more images. Preferably determining said presence of said anomaly comprises verifying that said spatial relationship exceeds a threshold criterion. Preferably said spatial relationship is a distance. Preferably said physical characteristic belongs to said member. The comparison between the positions assumed in the images by the physical characteristic (e.g. by the member or parts thereof) is very simple and effective for the purposes of detecting anomalies.

Preferably the method comprises associating to each respective image a respective acquisition instant. Preferably the method comprises time-ordering said images as a function of said respective acquisition instants.

Preferably said comparing comprises making and viewing a video comprising said images of the said collection of images time-ordered, and wherein said determining said presence of an anomaly comprises, by an operator and/or an image processing algorithm and/or an artificial intelligence program, determining in said video one or more spy images wherein a visual aspect of said portion of industrial machine is different with respect to remaining images of said video. This video is particularly useful for detecting, in simple and effective way, the presence and type of anomalies, e.g. breakages, slippages, bad positioning, but also position drift, wear, etc.

Preferably said given cycle of movement is temporally close to a machine stop by an operator, more preferably it is immediately preceding said machine stop. In other words, the method of the present invention is applied to machine downtime for diagnostic purposes of anomalies (possible presence and type) during machine downtime.

Preferably said image acquisition system comprises an image acquisition device structured for acquiring images in a visible spectrum. Preferably said images are 2D images. Preferably said images are digital images. Preferably said images are matrix images. Preferably said image acquisition system comprises an illuminator structured for illuminating said portion of industrial machine. Image acquisition is thus simple and reliable.

Preferably said processing unit comprises a RAM intended for storing said collection of images.

Preferably said processing unit is configured and programmed for making and reproducing a video comprising said images of said collection of images time-ordered.

### BRIEF DESCRIPTION OF THE DRAWINGS

FIG. 1 schematically shows one embodiment of an industrial machine according to the present invention;

FIGS. 2a-c schematically shows a respective image acquired at a respective value of the phase during a same cycle of movement of a member of the machine of FIG. 1;

FIG. 3 schematically shows three collections of images taken respectively at three different values of the phase f.

### DETAILED DESCRIPTION OF SOME EMBODIMENTS OF THE INVENTION

The features and the advantages of the present invention will be further clarified by the following detailed description of some embodiments, presented by way of example and not as limitation of the present invention, with reference to the attached figures.

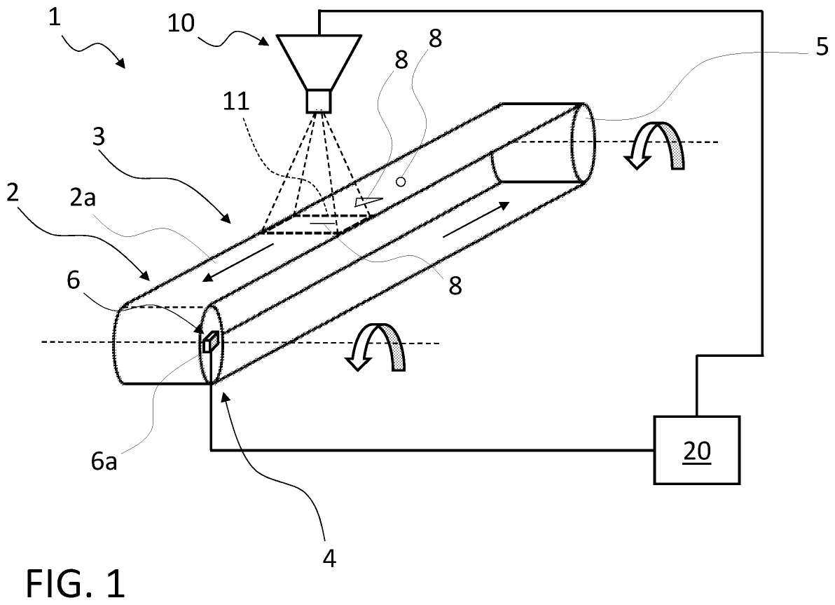

In FIG. 1 with the reference number 1 an industrial machine according to the present invention is exemplarily shown.

Preferably the industrial machine comprises a member 2 which moves according to a succession of cycles of movement having a phase. Exemplarily, the member 2 is a belt 2a of a conveyor belt 3, comprising, in addition to the belt 2a, a motorized roller 4 and a return roller 5, idle. The motorized roller 4 comprises, not shown, a motor structured to rotate a roller (in the figure according exemplarily to the direction indicated by the circular arrows) which moves the belt 2a along a closed recirculation path created by the motorized roller 4 and the return roller 5 (in the figure exemplarily according to the direction indicated by the straight arrows). In other words, the motor, through the motorized roller 4 in direct contact with the belt 2a, moves the belt 2a which passes through a succession of cycles of movement along a closed path coinciding with an instantaneous development of the belt 2a itself. Conventionally, the cycle of movement of the belt 2a has a phase that goes from 0° to 360° in each cycle of movement, such that each value of the phase corresponds to one and only one position of the belt 2a in the space. For the purposes of visualizing this position of the belt 2a in the space, the figures exemplarily show three reference symbols 8, respectively a segment, a triangle and a circle, drawn on the belt 2a and therefore integral with it. The position in the space of the symbols 8 is uniquely correlated with the phase of the cycle of movement of the belt 2a.

Preferably the industrial machine comprises a phase detector 6, more preferably structured for detecting in real time a value of the phase of the current cycle of movement of the belt 2a.

Preferably the phase detector 6 comprises an encoder 6a directly associated to an axis of rotation of the motorized roller 4 (and/or of the return roller 5), or associated to an axis of the motor, for directly detecting an angular position of the motorized roller 4 or if the axis of the motor. Preferably this angular position is synchronous with, or correlated to, the phase of the belt 2a (in absence of slippage between belt 2a and motorized roller 4, or return roller 5), for example according to a predetermined correlation between each complete revolution of the axis of the motorized roller 4 and a corresponding variation in the phase of the belt (e.g. each revolution of the motorized roller 4, or of the return roller 5, corresponds to 10° of phase variation of the belt 2a). In this way it is possible to calculate, by the phase detector 6, the value of the phase of the belt 2a as a function of the detected angular position of the motorized roller 4. In other words, the encoder 6a detects the phase of the belt 2a not in direct way, but indirectly by detecting the phase (or equivalently the angular position) of the motorized roller 4 or of the motor of the motorized roller 4.

Preferably the industrial machine comprises an image acquisition system 10, more preferably structured for acquiring an image of a portion 11 of the industrial machine. Preferably the image acquisition system 10 comprises an image acquisition device structured for acquiring 2D digital images in the visible spectrum, more preferably matrix images, e.g. a common digital camera having a matrix sensor. Preferably the image acquisition system 10 comprises, not shown, an illuminator structured for illuminating the portion 11 of the industrial machine. Exemplarily, the portion 11 of the machine that is acquired is a rectangular portion of the belt 2a corresponding moment by moment to the field of vision of the image acquisition device (indicated in broken lines in FIG. 1).

Preferably the industrial machine comprises a processing unit 20, more preferably connected to the image acquisition system 10 and to the phase detector 6, as exemplarily shown in FIG. 1 by two connection lines, which can be with or without wire (electrical and/or optical). Preferably the processing unit 20 comprises a RAM (not shown) intended for storing the received images.

Preferably the processing unit 20 is configured and programmed for receiving the value of the phase from the phase detector 6. It is observed that, although the phase detector 6 is illustrated in FIG. 1 as distinct and separate from the processing unit 20 and entirely located at the motorized roller 4, it is nevertheless contemplated that a part of the phase detector 6 is physically and/or or logically integrated with the processing unit 20, for example in the form of a hardware and/or software computational module. In this case the encoder 6a can send a signal representative of the angular position of the motorized roller 4 to the aforementioned hardware and/or software computational module of the phase detector 6, which is configured and programmed for calculating the value of the phase of the belt 2a as a function of the angular position of the motorized roller 4.

Preferably the processing unit 20 is configured and programmed for implementing the method for detecting an anomaly in the industrial machine 1 according to the present invention.

Preferably it is provided acquiring in real time the value of the phase, for example by means of the encoder 6a and the phase detector 6.

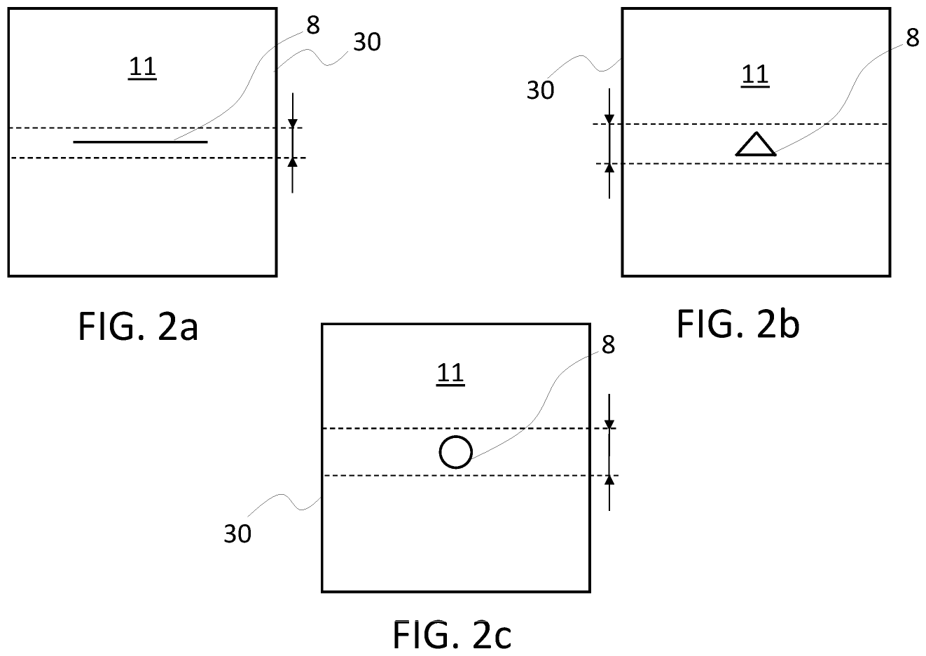

Exemplarily, at three certain values of the phase of each cycle of movement, the processing unit 20 commands the image acquisition system 10 to acquire a respective image 30 of the portion 11 of the industrial machine. FIGS. 2a-2c show exemplarily three images acquired at three different values of the phase of a same cycle of movement of the belt 2a, these values of phase being determined so that a respective reference symbol 8 is ideally located at the centre of the respective image 30.

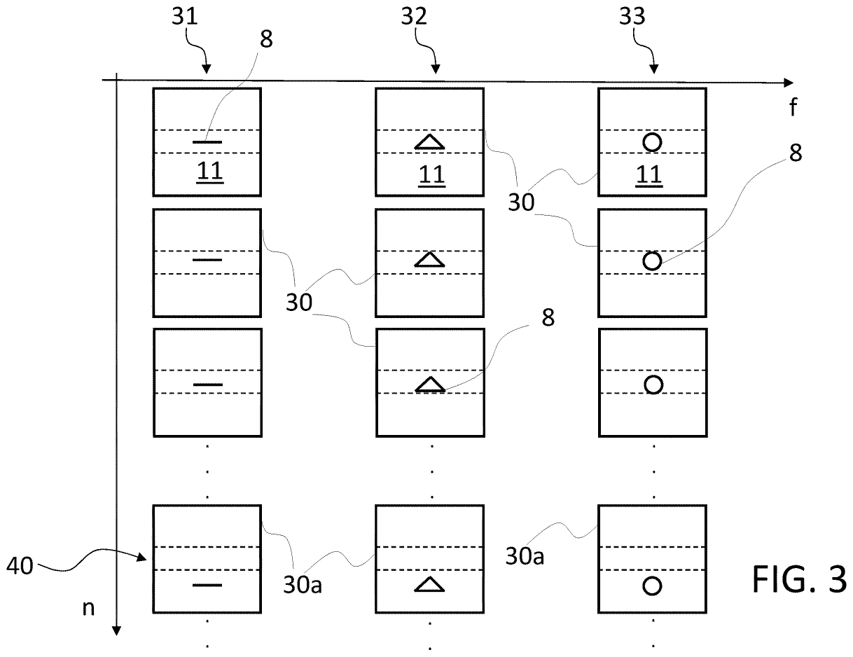

Preferably the processing unit stores, for example in the RAM, the three respective images acquired 30 in each cycle of movement to respectively obtain three collections of images 31, 32, 33 of the portion 11 of industrial machine. FIG. 3 exemplarily shows the three collections of images 31, 32, 33 taken respectively at the three different values of the phase f, for a number n of cycles of movement.

Preferably the method provides comparing the three images 30a of each collection of images 31, 32, 33 acquired in a given cycle of movement 40 with one or more images of the respective collection of images 31, 32, 33 acquired respectively in one or more cycles of movement prior to the given cycle of movement 40. For example, this comparison concerns the visual aspect of the portion 11 of machine as represented in the digital images 30.

Preferably the method provides determining the presence of an anomaly in the industrial machine, as a function of this comparison.

This comparison and determination of the presence of an anomaly can be performed visually by an operator and/or by the processing unit 20 via metric image processing algorithms (e.g. capable of recognizing the position of the elements represented in the image and to calculate the dimensions and/or relative distances of these elements) and/or through image recognition algorithms which allow for example the training of a neural network (or other algorithms classifiable as belonging to “machine learning” or artificial intelligence”) on one or more images of the respective collection of images acquired respectively in one or more cycles of movement prior to the given cycle of movement 40, such previous cycles of movement referring to normal operating conditions of the machine.

Exemplarily the comparison between the image of the cycle of movement 40 and the one or more images of the previous cycles comprises comparing the spatial relationship, e.g. the apparent distance (e.g. measured in pixels), between the position of a physical characteristic of the portion 11 of machine in the image of the cycle of movement 40 (e.g. the position of the reference symbols 8 as shown in FIG. 3) and the respective position of the physical characteristic in one or more previous images.

Preferably determining the presence of an anomaly comprises verifying that this spatial relationship exceeds a threshold criterion. For example, with reference to FIG. 3, the method allows to detect an anomaly in the movement of the belt 2a at the cycle of movement 40 (e.g. due to a mechanical slippage of the belt or an anomaly in the motorized roller 4), since the position of the symbols 8 in the images 30a differs from the position of the symbols 8 in the previous images 30 of the respective collection of images 31, 32 and 33 by a value greater than a certain threshold value, represented by the two dashed lines in the FIGS. 2 and 3.

Preferably the processing unit 20 is configured and programmed for making and reproducing a respective video comprising the images of respectively each collection of images 31, 32, 33 time-ordered. For example, the operator can view this video taken close to (e.g. immediately before) each machine stop. With reference to FIG. 3, this video can consist in the display in rapid succession of the images 30 of each collection of images 31, 32, 33. In this case the operator can identify the image 30a in the respective video, since the difference in the visual aspect is evident as the images scroll.

It is also possible making and reproducing a respective video comprising the images relative to a given cycle, ordered by value of the phase. In other words, with reference to FIG. 3, for example corresponding to the cycle of movement 40 the respective video comprises the images 30a ordered by increasing or decreasing values of the phase.

It is noted that the aforementioned method can be replicated for one or more further portions of machine (not shown). In this case, at the determined value of the phase of each cycle of movement, one or more further respective images of respectively one or more further portions of industrial machine are acquired, to respectively obtain one or more further collections of images. Subsequently, the comparison between images is also performed within these one or more further collections of images, in order to also check these further portions of machine with the present method.

1-15. (canceled)

16. A method for detecting an anomaly in an industrial machine, wherein the industrial machine comprises a member which moves according to a succession of cycles of movement having a phase, wherein the method comprises:
at a determined value of the phase of each cycle of movement, acquiring a respective image of a portion of the industrial machine, to obtain a collection of images of the portion of industrial machine;
comparing an image of the collection of images acquired in a given cycle of movement with one or more images of the collection of images acquired respectively in one or more cycles of movement prior to the given cycle of movement; and
as a function of the comparing, determining the presence of an anomaly in the industrial machine.

17. The method according to claim 16, wherein the method comprises:
at a plurality of determined values of the phase of each cycle of movement, wherein the plurality of determined values comprises the determined value, acquiring a plurality of respective images of the portion of the industrial machine, to obtain a plurality of collections of images, wherein the plurality of collection of images comprises the collection of images;
for each collection of images, comparing an image of each collection of images acquired in the cycle of movement with one or more images of each collection of images acquired respectively in the one or more cycles of movement prior to the given cycle of movement; and
as a function of the comparing, determining the presence of an anomaly in the industrial machine.

18. The method according to claim 16, wherein the method comprises:
at the determined value of the phase of each cycle of movement, acquiring a further respective image of a further portion of the industrial machine, to obtain a further collection of images;
comparing a further image of the further collection of images acquired in the given cycle of movement with one or more further images of the further collection of images acquired respectively in the one or more cycles of movement prior to the given cycle of movement; and
as a function of the comparing, determining the presence of an anomaly in the industrial machine.

19. The method according to claim 16, wherein the portion of machine at least partially comprises the member and the anomaly involves the member.

20. The method according to claim 16, wherein in the portion of machine passes/is placed a product under processing by the industrial machine.

21. The method according to claim 16, wherein the method comprises acquiring in real time a value of the phase by means of an encoder.

22. The method according to claim 16, wherein comparing the image with the one or more images comprises comparing a visual appearance of the portion of machine.

23. The method according to claim 16, wherein comparing the image with the one or more images comprises comparing a spatial relationship between a position of a physical characteristic of the portion of machine in the image and a respective position of the physical characteristic in the one or more images and wherein determining the presence of the anomaly comprises verifying that the spatial relationship exceeds a threshold criterion.

24. The method according to claim 16, wherein comparing comprises making and viewing a video comprising the images of the collection of images time-ordered, and wherein determining the presence of an anomaly comprises determining in the video one or more spy images wherein a visual aspect of the portion of industrial machine is different with respect to remaining images of said video.

25. An industrial machine comprises:
a member movable according to a succession of cycles of movement, wherein the succession of cycles of movement has a phase,
an image acquisition system structured for acquiring an image of a portion of the industrial machine;
a phase detector structured for detecting in real time a value of the phase; and
a processing unit connected to the image acquisition system and to the phase detector, wherein the processing unit is configured and programmed for:
receiving from the phase detector the value of the phase,
at a determined value of the phase of each cycle of movement, sending a control signal to the image acquisition system for acquiring a respective image of the portion of industrial machine;
storing in memory the respective image acquired in each cycle of movement to obtain a collection of images;
comparing an image of the collection of images acquired in a given cycle of movement with one or more images of the collection of images acquired respectively in one or more cycles of movement prior to the given cycle of movement; and
as a function of the comparing, determining the presence of an anomaly in the industrial machine.

26. The machine according to claim 25, wherein the image acquisition system comprises an image acquisition device structured for acquiring 2D matrix images in a visible spectrum and an illuminator structured for illuminating the portion of industrial machine.

27. The machine according to claim 25, wherein the phase detector comprises an encoder.

28. The machine according to claim 25 comprises a motor element structured for moving the member according to the succession of cycles of movement, wherein the encoder is directly associated to the motor element for detecting a respective angular position of the motor element, wherein the phase detector is configured and programmed for calculating the value of the phase as a function of the angular position of the motor element.

29. The machine according to claim 25, wherein the processing unit comprises a RAM intended for storing the collection of images.

30. The machine according to claim 25, wherein the processing unit is configured and programmed for making and reproducing a video comprising the images of the collection of images time-ordered.
